(19) United States
(12) Patent Application Publication
(10) Pub. No.: US 2026/0368860 A1
(43) Pub. Date: Nov. 19, 2026

(54) POINT CLOUD DATA PROCESSING DEVICE, POINT CLOUD DATA PROCESSING METHOD, AND RECORDING MEDIUM

(71) Applicant: Nuvoton Technology Corporation Japan, Kyoto (JP)

(72) Inventors: Kei UEDA, Kyoto (JP); Tetsuro OKUYAMA, Kyoto (JP)

(21) Appl. No.: 19/728,412

(22) Filed: Jul. 2, 2026

Related U.S. Application Data
(63) Continuation of application No. PCT/JP2025/000906, filed on Jan. 14, 2025.
(60) Provisional application No. 63/621,365, filed on Jan. 16, 2024.

(51) Int. Cl. G06T 5/50; G06T 5/20

(52) U.S. Cl. CPC G06T 5/50; G06T 5/20; G06T 2207/10028; G06T 2207/20212

(57) ABSTRACT

A point cloud data processing device includes: a first measurer that captures a first range image using an unstructured light; a second measurer that captures a second range image using a structured light; an image processor that generates a difference image indicating a difference between the first range image and the second range image; a point cloud converter that performs, based on the first range image captured by the first measurer, point cloud conversion on a distance value included in the first range image, and generates first point cloud data; a corrected data generator that generates corrected point cloud data based on the difference image generated by the image processor; and a point cloud corrector that generates blended point cloud data by correcting the first point cloud data.

### CROSS REFERENCE TO RELATED APPLICATIONS

This is a continuation application of PCT International Patent Application No. PCT/JP2025/000906 filed on Jan. 14, 2025, designating the United States of America, which is based on and claims priority of U.S. Provisional Patent Application No. 63/621,365 filed on Jan. 16, 2024. The entire disclosures of the above-identified applications, including the specifications, drawings and claims are incorporated herein by reference in their entirety.

### FIELD

The present disclosure relates to a point cloud data processing device, a point cloud data processing method, and a recording medium.

### BACKGROUND

Time of Flight (ToF) is a technique used to measure a distance to an object. Specifically, ToF is a technique for exposing an imaging element to reflected light during exposure periods having different timings, and calculating a distance to an object based on the amount of delay of the reflected light obtained from a signal-to-noise ratio corresponding to each exposure period, the reflected light being light emitted from a light source and reflected from the object.

Here, a range value obtained by ToF includes errors caused by exposing the imaging element to light emitted from the light source and reflected from the object multiple times as reflected light, that is, errors caused by multipath.

Patent Literature (PTL) 1 discloses a technique for mitigating errors included in range images captured by a ToF camera and showing distance measurement results.

### CITATION LIST

### Patent Literature

PTL 1: U.S. Pat. No. 9,329,035

### SUMMARY

### Technical Problem

The present disclosure provides, for example, a point cloud data processing device that makes it possible to mitigate errors caused by multipath in point cloud data.

### Solution to Problem

A point cloud data processing device according to one aspect of the present disclosure includes: a first distance measurer that captures a first range image using an unstructured light; a second distance measurer that captures a second range image using a structured light; an image processor that generates a difference image based on the first range image captured by the first distance measurer and the second range image captured by the second distance measurer, the difference image indicating a difference between the first range image and the second range image; a point cloud converter that performs, based on the first range image captured by the first distance measurer, point cloud conversion on a distance value included in the first range image, and generates first point cloud data; a corrected data generator that generates corrected point cloud data based on the difference image generated by the image processor; and a point cloud corrector that generates blended point cloud data by correcting the first point cloud data based on the corrected point cloud data generated by the corrected data generator.

A point cloud data processing method according to one aspect of the present disclosure includes: capturing a first range image using an unstructured light; capturing a second range image using a structured light; generating a difference image based on the first range image captured in the capturing of the first range image and the second range image captured in the capturing of the second range image, the difference image indicating a difference between the first range image and the second range image; performing, based on the first range image captured in the capturing of the first range image, point cloud conversion on a distance value included in the first range image, and generating first point cloud data; generating corrected point cloud data based on the difference image generated in the generating of the difference image; and generating blended point cloud data by correcting the first point cloud data based on the corrected point cloud data generated in the generating of the corrected point cloud data.

It should be noted that the present disclosure can be implemented not only as the above point cloud data processing method but also as a program for causing a computer to execute the point cloud data processing method. Additionally, the present disclosure can be implemented as a computer-readable recording medium having recorded on the program.

### Advantageous Effects

The point cloud data processing device, the point cloud data processing method, and the recording medium according to the present disclosure make it possible to mitigate errors caused by multipath in point cloud data.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an overview of a point cloud data processing device according to an embodiment.

FIG. 2 is a diagram for illustrating multipath in ToF.

FIG. 3 is a block diagram showing a functional configuration of the point cloud data processing device according to the embodiment.

FIG. 4 is a diagram showing an example of a first range image according to the embodiment.

FIG. 5 is a diagram showing an example of a second range image according to the embodiment.

FIG. 6 is a diagram for illustrating point cloud conversion.

FIG. 7 is a flowchart illustrating operations performed by the point cloud data processing device according to the embodiment.

FIG. 8 is a diagram showing an example of a reduced image according to the embodiment.

FIG. 9 is a diagram showing an example of an interpolated image according to the embodiment.

FIG. 10 is a diagram showing an example of a difference image according to the embodiment.

FIG. 11 is a diagram showing an example of a corrected image according to the embodiment.

FIG. 12 is a diagram for illustrating first point cloud data and blended point cloud data according to the embodiment.

FIG. 13 is a flowchart illustrating operations performed by a point cloud data processing device according to Variation 1 of the embodiment.

FIG. 14 is a diagram for illustrating mask processing according to the embodiment.

FIG. 15 is a flowchart illustrating operations performed by a point cloud data processing device according to Variation 2 of the embodiment.

FIG. 16 is a diagram for illustrating Dot enablement processing according to the embodiment.

FIG. 17 is a diagram for illustrating a time-series filtering process according to the embodiment.

### DESCRIPTION OF EMBODIMENT

### Embodiment

Hereinafter, a point cloud data processing device, a point cloud data processing method, and a recording medium according to an embodiment of the present disclosure are described in detail with reference to the Drawings. It should be noted that the embodiment described below shows a specific example of the present disclosure. The numerical values, the constituent elements, the arrangement and connection of the constituent elements, the steps, the order of the steps, and the like shown in the following embodiment are mere examples, and are not intended to limit the present disclosure. In addition, among the constituent elements in the following embodiment, those that are not recited in the independent claims are described as optional constituent elements included in an embodiment.

It should be noted that each of the figures is a schematic diagram and is not necessarily drawn to scale. Additionally, substantially the same constituent elements are assigned the same reference signs in the figure, and any overlapping description may be omitted or simplified.

Moreover, unless otherwise noted, the ordinal such as “first” and “second” in the present disclosure does not refer to the number or order of constituent elements or the like and is used to avoid confusion between and distinguish among constituent elements of the same type or the like.

Furthermore, unless otherwise noted, a “frequency” in the present disclosure refers to a “spatial frequency”. A spatial frequency is a physical quantity corresponding to the reciprocal of a distance.

### [Overview]

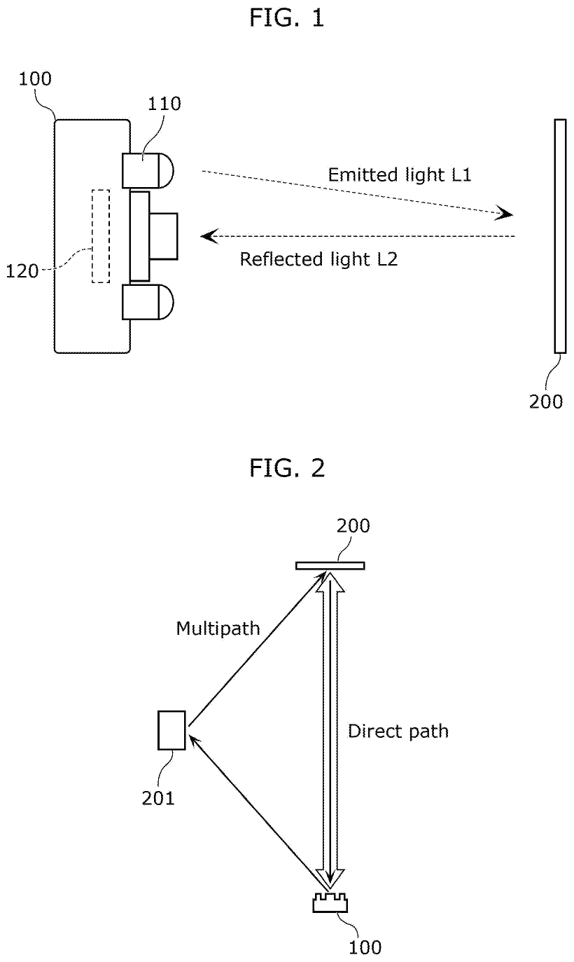

First, an overview of a point cloud data processing device according to the present embodiment is described. FIG. 1 is a schematic diagram illustrating an overview of point cloud data processing device 100 according to the embodiment. FIG. 2 is a diagram for illustrating multipath in ToF.

As shown in FIG. 1, point cloud data processing device 100 includes light emitter 110 and exposure unit 120. Point cloud data processing device 100 causes light emitter 110 to emit light (also referred to as emitted light) L1 into a space. Light L1 emitted into the space is reflected from object 200, and exposure unit 120 is exposed to light L1 as reflected light L2. At this time, exposure unit 120 is exposed to light during exposure periods having timings different from light emission timings.

Point cloud data processing device 100 makes it possible to measure a distance to object 200 by calculating a time from when light emitter 110 emits light L1 to when exposure unit 120 is exposed to reflected light L2, based on a signal quantity corresponding to each of the exposure periods.

In measuring a distance using ToF, it is known that errors caused by multipath are included in the measurement result. As shown in FIG. 2, when light emitted by light emitter 110 travels along a direct path, that is, light emitted by light emitter 110 directly hits target object 200 and is reflected from target object 200, errors relative to a true distance are not easily caused. However, actually, multipath in which a portion of light emitted by light emitter 110 hits and is reflected from object 201 and then hits and is reflected from target object 200 may be caused. Although there is one indirect path in the example shown in FIG. 2, a plurality of indirect paths may exist.

As shown in FIG. 2, the light traveling along the indirect path returns to point cloud data processing device 100 later than the light traveling along the direct path. For this reason, a distance calculated relative to the time of flight of the light traveling along the indirect path is longer than the true distance.

For example, when a distance to a wall surface is measured using point cloud data processing device 100, a path along which light returns to point cloud data processing device 100 after the light is reflected first from a floor surface and then from the wall surface is an example of an indirect path.

In fact, the light reflected from target object 200 and returning to point cloud data processing device 100 includes the light traveling along the direct path and the light traveling along the indirect path. As a result, the distance calculated by point cloud data processing device 100 includes errors caused by multipath and causing the distance to be longer than a true distance.

Point cloud data processing device 100 according to the embodiment makes it possible to mitigate errors caused by multipath in point cloud data showing the result of a distance measurement using ToF.

### [Configuration]

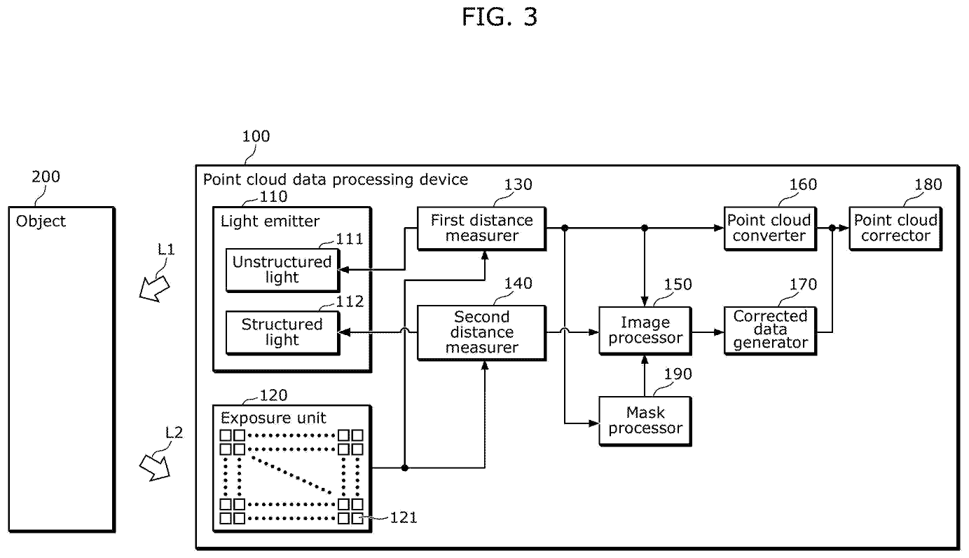

A configuration of point cloud data processing device 100 according to the embodiment is described below. FIG. 3 is a block diagram showing a functional configuration of point cloud data processing device 100 according to the embodiment.

Point cloud data processing device 100 generates point cloud data based on a range image captured by ToF and including distance values. A distance value included in the range image indicates a distance to object 200. Point cloud data is data indicating a set of points in a space. Point cloud data is, for example, three-dimensional point cloud data indicating a set of plurality of points having three-dimensional coordinates. Moreover, point cloud data processing device 100 makes it possible to mitigate errors caused by multipath in the point cloud data, by performing information processing for correcting the point cloud data. Specifically, point cloud data processing device 100 includes light emitter 110, exposure unit 120, first distance measurer 130, second distance measurer 140, image processor 150, point cloud converter 160, corrected data generator 170, point cloud corrector 180, and mask processor 190.

Light emitter 110 is a light source that emits light L1 into a space according to a light emission control signal inputted. For example, light emitter 110 emits pulsed light as light according to a timing indicated by a light emission control pulse included in a light emission control signal inputted. Light emitter 110 repeatedly emits pulsed light at predetermined intervals according to a light emission control signal.

Light emitter 110 is implemented by, for example, a light source including a light-emitting diode that emits infrared light or a laser element. Light emitter 110 is implemented by a light-emitting element that has a relatively high response speed and is capable of high-speed flashing, and an optical system that receives light from the light-emitting element and controls the distribution of the light from the light-emitting element. Light emitter 110 includes a plurality of light sources that emit light in spatially different configurations into a space. The spatially different configurations refer to different intensity distributions of light emitted by light emitter 110 into the space. Specifically, light emitter 110 includes unstructured light 111 and structured light 112.

Unstructured light 111 emits light having a uniform intensity distribution. Unstructured light 111 is also referred to as a flood light source or a patternless light source. More specifically, unstructured light 111 emits light having a uniform intensity distribution relative to the view angle of a camera (i.e., the light receiving range of exposure unit 120).

Structured light 112 emits light having a non-uniform intensity distribution. The non-uniform intensity distribution is, for example, a dot cycle pattern. Structured light 112 is also referred to as a dot light source or a pattern light source. More specifically, structured light 112 emits light having a specific pattern such as a dot array relative to the view angle of the camera. In the embodiment, structured light 112 emits light having a light distribution that causes high-intensity portions of light to be a set of points arranged in a two-dimensional array in the vertical and horizontal directions.

Exposure unit 120 is implemented by, for example, a pixel array. Exposure unit 120 is exposed to light during a plurality of exposure periods having timings that are different from each other and relative to timings at which unstructured light 111 or structured light 112 emits light.

Exposure unit 120 includes a plurality of pixels 121 arranged in a two-dimensional array. Each of the plurality of pixels 121 generates a signal based on incident light. For example, each of the plurality of pixels 121 converts incident light into signal charge, and generates a signal based on the signal charge obtained by the conversion. The incident light on pixel 121 is reflected light from object 200 and background light from a surrounding area. The plurality of pixels 121 each include a substantially identical configuration. It is possible to expose the plurality of pixels 121 to light multiple times within one frame at a timing indicated by a light exposure control signal outputted from first distance measurer 130 or second distance measurer 140. Here, a frame is a period from when the plurality of pixels 121 are exposed to light to when signals are read out from the plurality of pixels 121, which is defined as one cycle.

First distance measurer 130, second distance measurer 140, image processor 150, point cloud converter 160, corrected data generator 170, point cloud corrector 180, and mask processor 190 are, for example, functional processors each implemented by a memory that stores a program, a processor that executes a program, and the like. It should be noted that although first distance measurer 130, second distance measurer 140, image processor 150, point cloud converter 160, corrected data generator 170, point cloud corrector 180, and mask processor 190 are discrete in the block diagram shown in FIG. 3, at least one of first distance measurer 130, second distance measurer 140, image processor 150, point cloud converter 160, corrected data generator 170, point cloud corrector 180, or mask processor 190 may be configured in the same memory and processor. Additionally, at least one of first distance measurer 130, second distance measurer 140, image processor 150, point cloud converter 160, corrected data generator 170, point cloud corrector 180, or mask processor 190 may be implemented by a dedicated logic circuit that performs predetermined processing.

First distance measurer 130 performs information processing for outputting a first range image. Specifically, first distance measurer 130 outputs a light emission control signal for driving unstructured light 111. In addition, first distance measurer 130 outputs a light exposure control signal for driving exposure unit 120. The light exposure control signal is a signal for exposing each of the plurality of pixels 121 to light at a timing corresponding to a timing at which unstructured light 111 emits light L1. Moreover, first distance measurer 130 performs signal processing regarding a signal outputted by each of the plurality of pixels 121, calculates a distance to object 200, and generates the first range image. In other words, first distance measurer 130 captures the first range image by performing the above information processing.

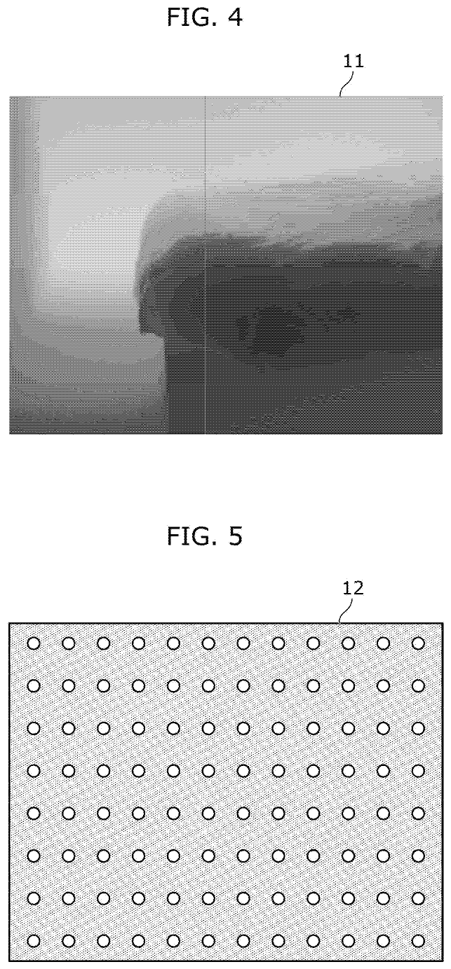

First distance measurer 130 is implemented by, for example, a drive circuit that outputs a light emission control signal for driving unstructured light 111 and a light exposure control signal for driving exposure unit 120, and an information processing circuit that performs information processing for generating a range image based on signals obtained from exposure unit 120. FIG. 4 is a diagram showing an example of first range image 11 according to the embodiment.

As shown in FIG. 4, first range image 11 represents a set of distance values to object 200 calculated based on signals each obtained from a corresponding one of the plurality of pixels 121.

Since first range image 11 is a range image captured using unstructured light 111, distance values may be calculated for all pixels 121 included in exposure unit 120.

Second distance measurer 140 performs information processing for outputting a second range image. Specifically, second distance measurer 140 outputs a light emission control signal for driving structured light 112. In addition, second distance measurer 140 outputs a light exposure control signal for driving exposure unit 120. The light exposure control signal is a signal for exposing each of the plurality of pixels 121 to light at a timing corresponding to a timing at which structured light 112 emits light L1. Moreover, second distance measurer 140 performs signal processing regarding a signal outputted by each of the plurality of pixels 121, calculates a distance to object 200, and generates the second range image. In other words, second distance measurer 140 captures the second range image by performing the above information processing.

Second distance measurer 140 is implemented by, for example, a drive circuit that outputs a light emission control signal for driving structured light 112 and a light exposure control signal for driving exposure unit 120, and an information processing circuit that performs information processing for generating a range image based on signals obtained from exposure unit 120. FIG. 5 is a diagram showing an example of second range image 12 according to the embodiment.

A portion indicated by a white circle in FIG. 5 represents a distance value calculated based on a signal outputted by pixel 121 that receives a sufficient amount of light for distance measurement. Hereinafter, such pixel 121 is referred to as an effective pixel. In contrast, a portion indicated by a dot (i.e., a portion other than a white circle) in FIG. 5 represents pixel 121 that does not receive a sufficient amount of light for distance measurement.

Since second range image 12 is a range image captured using structured light 112, the intensity distribution of light emitted by structured light 112 is reflected in second range image 12. In other words, the effective pixels are arranged to be a set of points in a two-dimensional array in the vertical and horizontal directions in second range image 12 shown in FIG. 5.

The following briefly describes an example of a procedure in which first distance measurer 130 and second distance measurer 140 perform signal processing regarding a signal outputted by each of the plurality of pixels 121 and calculate a distance to object 200. Here, the outline of the procedure also referred to as a pulse ToF method is described.

The drive circuit causes light emitter 110 to emit a pulse (an emitted pulse) having pulse width P1, and exposes pixel 121 to light during two exposure periods of exposure period A0 and exposure period A1 each having a duration corresponding to pulse width P1. Exposure period A0 starts simultaneously with the start of a light emission control pulse. Exposure period A1 starts at a timing obtained by delaying the start of the light emission control pulse by pulse width P1, that is, starts simultaneously with the end of exposure period A0.

Reflected light from object 200 is received by pixel 121 with a delay of time Δt relative to emitted light depending on the distance to object 200. Accordingly, when object 200 is located within a distance measurement range that allows distance measurement, signal charge generated by the reflected light is distributed to signal charge generated during exposure period A0 and signal charge generated during exposure period A1 depending on the distance to object 200.

Time Δt that is the amount of delay is calculated by the following equation (1), where A0 is a signal value corresponding to exposure period A0, and A1 is a signal value corresponding to exposure period A1.

$$\begin{matrix}[ Math . 1 ] & \\ Δ t = P 1 \times \frac{A 1}{A 0 + A 1} & ( 1 )\end{matrix}$$

In addition, since emitted light travels a distance equal to twice distance D in time Δt, distance D is calculated by the following equation (2), where D is a distance to object 200, and c is the speed of light.

$$\begin{matrix}[ Math . 2 ] & \\ D = \frac{c \times Δ t}{2} = \frac{c \times P 1}{2} \times \frac{A 1}{A 0 + A 1} & ( 2 )\end{matrix}$$

It is possible to capture a range image including the value of distance D by performing the above procedure on each of the plurality of pixels 121.

It should be noted that although the example in which exposure period A0 starts simultaneously with the start of the light emission control pulse is described above, exposure period A0 may start later than the start of the light emission control pulse by a predetermined time. In consequence, it is possible to shift the upper and lower limits of the distance measurement range in a direction that increases a distance.

Moreover, a procedure for calculating a distance to object 200 is not limited to the above procedure. For example, the distance to object 200 may be calculated using a continuous wave (CW)-ToF method.

Image processor 150 performs information processing for generating a difference image based on first range image 11 captured by first distance measurer 130 and second range image 12 captured by second distance measurer 140, the difference image indicating a difference between first range image 11 and second range image 12. Additionally, image processor 150 performs information processing for generating a corrected image, by performing, on the generated difference image, a process for reducing frequency components each having a frequency higher than or equal to a predetermined first frequency. To put it another way, image processor 150 obtains a range image captured and performs information processing on the range image obtained. The predetermined first frequency is described in detail below.

Point cloud converter 160 performs, based on first range image 11 captured by first distance measurer 130, point cloud conversion on a distance value included in first range image 11, and performs information processing for generating first point cloud data. The point cloud conversion is a process for generating point cloud data by converting each of the distance values included in a range image into the coordinates of a point in an x-y-z coordinate system based on the range image and camera intrinsic parameters.

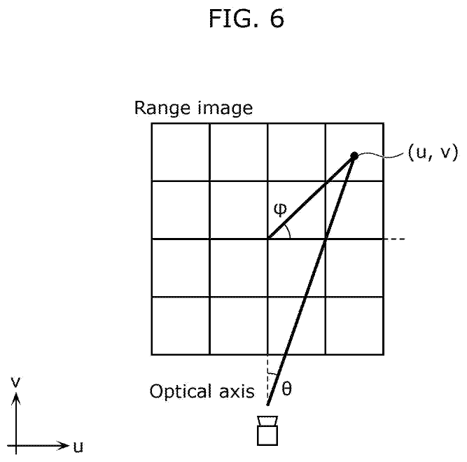

The following briefly describes a procedure for performing point cloud conversion on a distance value included in a range image. FIG. 6 is a diagram for illustrating point cloud conversion.

First, which position a pixel on which point cloud conversion is to be performed occupies in the range image is calculated using the u-v coordinate axes shown in FIG. 6 with the center of the range image as the origin. In other words, u represents a horizontal image coordinate, and v represents a vertical image coordinate. When a half angle of view corresponding to a distance from an optical axis of each pixel is denoted by θ, a rotation angle about the optical axis at each pixel position is denoted by φ, and camera intrinsic parameters are denoted by I, θ and φ depend on u, v, and I. To put it another way, it is possible to represent the dependence as θ (u, v, I) and φ (u, v, I). The camera intrinsic parameters include, for example, a position (a height) at which a distance measuring camera is disposed and the performance of the distance measuring camera.

Conversion coefficients are calculated based on θ and φ calculated. A conversion coefficient is a coefficient used for point cloud conversion and corresponding to each of an x-axis direction, a y-axis direction, and a z-axis direction.

When a conversion coefficient in the x-axis direction is denoted by paramX, a conversion coefficient in the y-axis direction is denoted by paramY, and a conversion coefficient in the z-axis direction is denoted by paramZ, the conversion coefficients are calculated by the following equation.

(paramX,paramY,paramZ)=(sin(θ)cos(φ),sin(θ)sin(φ),cos(θ)).

3D coordinates (x, y, z) of each of the plurality of pixels in the range image are calculated by the following equation based on the conversion coefficients calculated and distance value depth of the pixel.

(x,y,z)=(paramX×depth,paramY×depth,paramZ×depth)

By performing this calculation for each of the plurality of pixels, it is possible to convert a distance value into 3D coordinates.

Point cloud converter 160 performs point cloud conversion on a distance value included in first range image 11 using such a procedure, and generates first point cloud data.

Corrected data generator 170 performs information processing for generating corrected point cloud data, based on the difference image generated by image processor 150. Specifically, corrected data generator 170 performs point cloud conversion on a distance value included in, for example, the difference image or the corrected image, and generates corrected point cloud data.

Point cloud corrector 180 performs information processing for generating blended point cloud data by correcting the first point cloud data based on the corrected point cloud data generated by corrected data generator 170. For example, point cloud corrector 180 generates blended point cloud data by combining the first point cloud data and the corrected point cloud data. The blended point cloud data is point cloud data in which errors caused by multipath at the time of distance measurement are mitigated by information processing performed by point cloud data processing device 100.

Mask processor 190 performs information processing for extracting frequency components included in first range image 11 and each having a frequency higher than or equal to a predetermined second frequency, and generating a high-frequency image. The predetermined second frequency is described in detail below. Point cloud data processing device 100 need not include mask processor 190.

### [Operations]

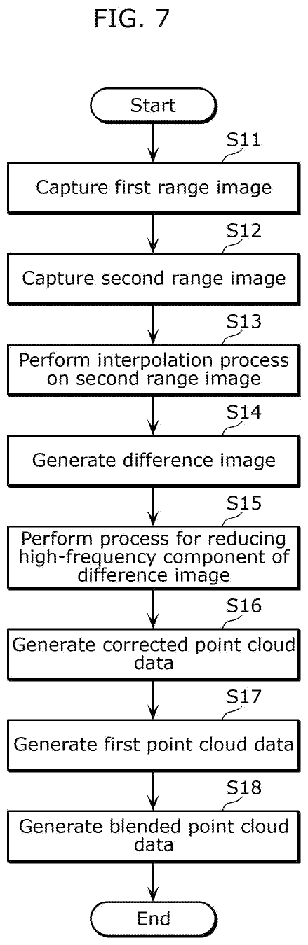

Next, operations performed by point cloud data processing device 100 according to the embodiment are described below. FIG. 7 is a flowchart illustrating operations performed by point cloud data processing device 100 according to the embodiment.

In general, DotToF (ToF using a structured light) makes it possible to mitigate errors caused by multipath, compared to FloodToF (ToF using an unstructured light).

On the other hand, DotToF results in significantly lower spatial resolution, compared to FloodToF.

In view of the above, by appropriately combining DotToF and FloodToF, point cloud data processing device 100 according to the embodiment makes it possible to mitigate errors caused by multipath while maintaining spatial resolution. More specifically, point cloud data processing device 100 according to the embodiment captures range images using different light sources including a Dot light source and a Flood light source, and makes it possible to generate, by correcting point cloud data obtained based on the range images, point cloud data in which errors caused by multipath included in the captured range images are mitigated.

First, first distance measurer 130 captures first range image 11 using unstructured light 111 (S11). First distance measurer 130 outputs first range image 11 captured to image processor 150 and point cloud converter 160.

Next, second distance measurer 140 captures second range image 12 using structured light 112 (S12). Second distance measurer 140 outputs second range image 12 captured to image processor 150.

When image processor 150 obtains second range image 12, image processor 150 performs an interpolation process on second range image 12 (S13). The interpolation process is a process for obtaining an image having the same number of pixels as the number of pixels in first range image 11 by interpolating invalid distance values included in second range image 12. The interpolation process includes a process for extracting effective pixels included in second range image 12. The interpolation process refers to, for example, a process for generating an image having the same number of pixels as the number of the pixels in first range image 11 based on second range image 12, by performing predetermined information processing on effective pixels included in second range image 12.

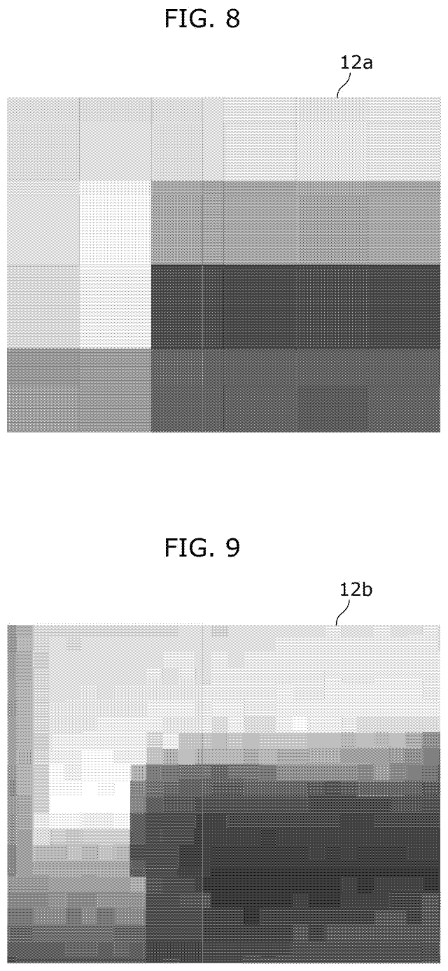

Specifically, first, image processor 150 generates a reduced image by extracting effective pixels included in second range image 12. FIG. 8 is a diagram showing an example of reduced image 12a according to the embodiment. As shown in FIG. 8, reduced image 12a is an image including only effective pixels included in second range image 12. In other words, reduced image 12a is an image including fewer pixels than second range image 12 does. The number of pixels in reduced image 12a may be, for example, equal to the number of high-intensity portions in the intensity distribution of light emitted by structured light 112.

Then, image processor 150 generates an interpolated image based on reduced image 12a. Specifically, image processor 150 interpolates pixels indicating appropriate distance values between the pixels in reduced image 12a by performing information processing to be described later on reduced image 12a. Accordingly, image processor 150 generates an interpolated image. FIG. 9 is a diagram showing an example of interpolated image 12b according to the embodiment. As shown in FIG. 9, interpolated image 12b is an image having the same number of pixels as the number of the pixels in first range image 11.

Although a method for generating interpolated image 12b based on reduced image 12a is, for example, a nearest neighbor interpolation method, such a method may be a bilinear interpolation method, a bicubic interpolation method, or the like. Additionally, interpolated image 12b may be generated through upsampling by applying a Joint-Bilateral Filter, a Guided Filter, and the like to reduced image 12a.

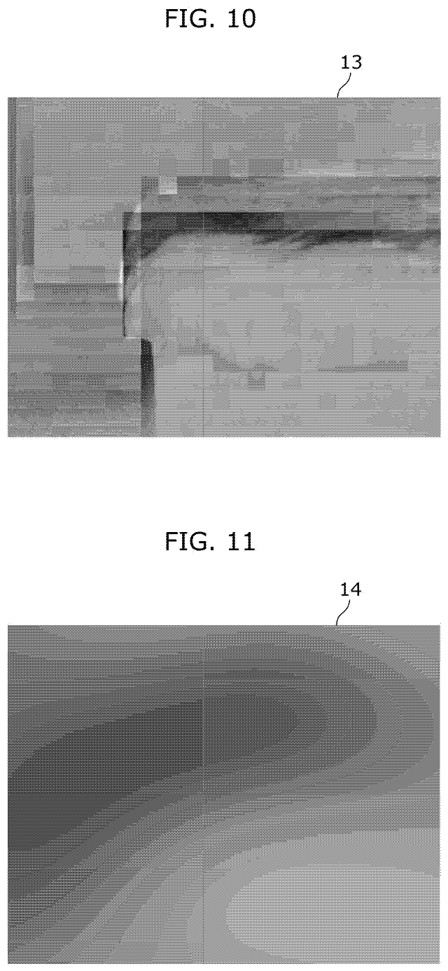

When image processor 150 generates interpolated image 12b, image processor 150 generates a difference image based on first range image 11 and interpolated image 12b (S14). FIG. 10 is a diagram showing an example of difference image 13 according to the embodiment. Difference image 13 is an image indicating differences between the distance values in first range image 11 and the distance values in interpolated image 12b. For example, in difference image 13 shown in FIG. 10, a portion having a darker color indicates a larger difference between a distance value included in first range image 11 and a distance value included in interpolated image 12b.

When image processor 150 generates difference image 13, image processor 150 performs a process for reducing high-frequency components of difference image 13 (S15). Image processor 150 performs the process for reducing the high-frequency components of difference image 13, and generates a corrected image. FIG. 11 is a diagram showing an example of corrected image 14 according to the embodiment.

Corrected image 14 shown in FIG. 11 is an image on which the process for reducing the high-frequency components of difference image 13 shown in FIG. 10 is performed. As shown in FIG. 11, the high-frequency components, that is, components representing spatially steep changes, are reduced in corrected image 14, compared to difference image 13 shown in FIG. 10.

Here, difference image 13 includes error components caused primarily by two factors.

The first factor is error components caused by first range image 11 having a low accuracy. The accuracy of first range image 11 is reduced by, for example, multipath and a low-reflectivity object. The error components represent relatively low-frequency components.

The second factor is error components caused by second range image 12 having a low resolution, that is, having fewer effective pixels. Since it is not possible to detect a steep depth shape, that is, a shape that is included in, for example, a thin object or a pointed object and in which changes in distance values between adjacent pixels are large due to the low resolution of second range image 12, the error components are generated. The error components represent relatively high-frequency components.

In view of the above, in step S15, image processor 150 makes it possible to extract the error components caused by the first factor, that is, the error components representing the relatively low-frequency components by performing the process for reducing the high-frequency components of difference image 13.

For example, image processor 150 performs frequency transform on difference image 13, and performs the process for reducing the high-frequency components included in difference image 13.

Specifically, image processor 150 performs a frequency transform process on difference image 13 using discrete Fourier transform. The frequency transform process may be performed using discrete Cosine transform, discrete Wavelet transform, discrete Hadamard transform, or discrete Haar transform. The method for performing the frequency transform process is not limited to the above transforms.

After that, image processor 150 performs a process for reducing frequency components each having a frequency higher than or equal to a predetermined first frequency. The amount of light received from structured light 112 is distributed on an image sensor having pixel pitch frequency fs according to pattern frequency fp. When the predetermined first frequency is denoted by fth, fth is, for example, a value that satisfies 0.1 fp<fth<fs. It should be noted that fth may be a value that satisfies another range, for example, a value that satisfies 0.2 fp<fth<1.2 fs.

The process for reducing a predetermined first frequency component may be, for example, a process for causing the predetermined first frequency component to be 0 on a spectrum or a process for reducing the predetermined first frequency component based on a specific functional form such as Gaussian.

Finally, image processor 150 performs a process for generating corrected image 14 by performing inverse frequency transform on difference image 13.

It should be noted that the process may be performed on all or part of the pixels included in difference image 13.

Alternatively, for example, image processor 150 performs the process for reducing the high-frequency components by applying a spatial filter to difference image 13.

Specifically, image processor 150 performs the process for reducing the high-frequency components by applying, to difference image 13, a spatial filter designed to reduce frequency components each having a frequency higher than or equal to the predetermined first frequency.

When the predetermined first frequency is denoted by fth, fth is, for example, a value that satisfies 0.1 fp<fth<fs. It should be noted that fth may be a value that satisfies another range, for example, a value that satisfies 0.2 fp<fth<1.2 fs. The size of the spatial filter is not particularly limited as long as the spatial filter has at least one of a vertical size larger than one pixel or a horizontal size larger than one pixel. For example, the vertical size may be one pixel and the horizontal size may be three pixels, or the vertical size may be three pixels and the horizontal size may be one pixel. Additionally, a direction along which the spatial filter extends may be any of an upward direction, a downward direction, a rightward direction, or a leftward direction.

Moreover, filtering processes may be performed separately in vertical and horizontal directions. For example, a spatial filter having a size of one pixel×three pixels and a spatial filter having a size of three pixels×one pixel may be applied separately, and a result obtained by combining the application results through an operation such as addition or multiplication may be used as a final result.

The amount of light received from structured light 112 is distributed on the image sensor having pixel pitch frequency fs according to pattern frequency fp. When the predetermined first frequency is denoted by fth, fth is, for example, a value that satisfies 0.1 fp<fth<fs. It should be noted that fth may be a value that satisfies another range, for example, a value that satisfies 0.2 fp<fth<1.2 fs.

It should be noted that the process may be performed on all or part of the pixels included in difference image 13.

Alternatively, for example, image processor 150 performs the process for reducing the high-frequency components included in difference image 13 using artificial intelligence (AI).

For example, image processor 150 generates corrected image 14 by inputting difference image 13 to image generation AI that is pre-trained on the error components caused by the first factor and the error components caused by the second factor.

The image generation AI is an AI model that is trained to extract the error components caused by the first factor from the error components included in difference image 13. Although the image generation AI is implemented by a ControlNet algorithm or a pix2pix algorithm, the image generation AI may be a model based on another algorithm.

It should be noted that the process may be performed on all or part of the pixels included in difference image 13.

Next, corrected data generator 170 generates corrected point cloud data based on corrected image 14 (S16). Specifically, corrected data generator 170 generates corrected point cloud data by performing point cloud conversion on a distance value included in corrected image 14.

Point cloud converter 160 generates first point cloud data based on first range image 11 (S17). Specifically, point cloud converter 160 generates first point cloud data 21 by performing point cloud conversion on the distance value included in first range image 11.

Finally, point cloud corrector 180 generates blended point cloud data by correcting first point cloud data 21 using the corrected point cloud data (S18). In other words, point cloud corrector 180 generates blended point cloud data by performing a point cloud correction process. The point cloud correction process is a process for generating blended point cloud data based on first point cloud data 21 obtained by performing the point cloud conversion on first range image 11 and the corrected point cloud data obtained by performing the point cloud conversion on corrected image 14. The point cloud correction process is performed by, for example, calculating a difference between first point cloud data 21 and the corrected point cloud data and reflecting the difference in first point cloud data 21. It should be noted that the point cloud correction process may be performed using another method.

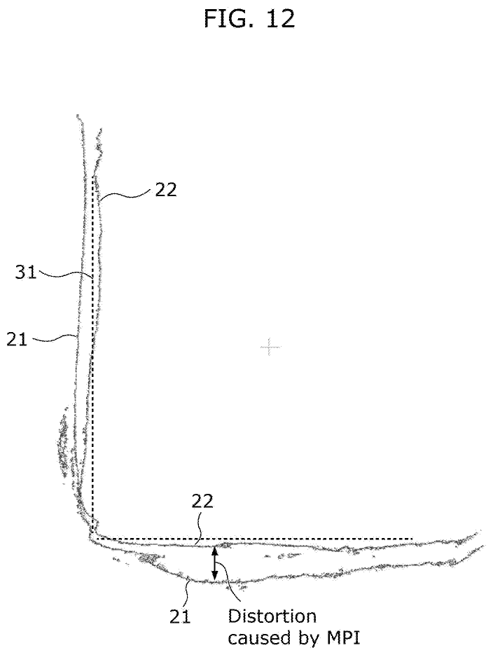

FIG. 12 is a diagram for illustrating first point cloud data 21 and blended point cloud data 22 according to the embodiment. FIG. 12 represents data obtained by slicing, along a cross-sectional plane on which an L shape appears, first point cloud data 21 and blended point cloud data 22 generated based on first range image 11 and second range image 12 obtained by capturing a portion in the L shape from an upper-right direction. The L shape is a shape prone to multipath at the time of distance measurement.

Ideal value 31 indicated by the L-shaped dashed line in FIG. 12 represents an actual shape captured. To put it another way, in FIG. 12, point cloud data including points whose positions are closer to ideal value 31 is considered to be point cloud data in which the actual shape is more accurately reconstructed and that has fewer errors.

Hereinafter, in ideal value 31 of the L shape shown in FIG. 12, the vertical dashed line is referred to as a wall surface and the horizontal dashed line is referred to as a floor surface.

As shown in FIG. 12, both on the wall surface and the floor surface, first point cloud data 21 is a point cloud generated based on distance values greater than actual distance values indicated in ideal value 31. In other words, first point cloud data 21 includes errors caused by multipath.

In contrast, blended point cloud data 22 is point cloud data including points close to ideal value 31, compared to first point cloud data 21. To put it another way, distortion caused by multipath interference (MPI), that is, errors caused by multipath, are mitigated in blended point cloud data 22.

Furthermore, in FIG. 12, for example, as seen in a point cloud of first point cloud data 21 representing the floor surface, first point cloud data 21 is a curved point cloud having high curvature, whereas blended point cloud data 22 is a substantially linear point cloud having relatively low curvature. In other words, blended point cloud data 22 is point cloud data that enables high-accuracy reconstruction of a linear shape, compared to first point cloud data 21.

Accordingly, as shown in FIG. 12, the actual shape is more accurately reflected in blended point cloud data 22 than in first point cloud data 21.

By performing the above operations, point cloud data processing device 100 according to the embodiment generates corrected point cloud data based on first range image 11 captured using unstructured light 111 and second range image 12 captured using structured light 112, corrects first point cloud data 21 obtained from first range image 11, based on the corrected point cloud data, and generates blended point cloud data 22.

Accordingly, such point cloud data processing device 100 makes it possible to generate point cloud data in which errors caused by multipath at the time of distance measurement are mitigated.

### Variation 1

Point cloud data processing device 100 according to the above embodiment makes it possible to generate blended point cloud data 22 in which errors caused by multipath are mitigated, by correcting first point cloud data 21 using corrected point cloud data. At this time, to mitigate errors caused by multipath, point cloud data processing device 100 generates corrected point cloud data by performing a process for reducing high-frequency components.

Here, since structured light 112 emits light having a light distribution in which high-intensity portions of the light are a set of points arranged in a two-dimensional array in the vertical and horizontal directions, a range image obtained using structured light 112 includes frequency components each having a frequency lower than or equal to fixed spatial frequency Fp defined by the light distribution. Consequently, it is not possible to obtain, from second range image 12, a distance value at a portion including a spatial frequency component having a spatial frequency higher than Fp. To put it another way, it is not possible to detect, in second range image 12, an object having a shape including steep depth changes such as a leg portion of a chair.

For this reason, a shape having a spatial frequency higher than or equal to Fp is not correctly reflected in corrected image 14. Accordingly, mask processing for protecting high-frequency components each having a frequency higher than or equal to the predetermined second frequency may be performed on corrected image 14 using a frequency filter that extracts the high-frequency components each having the frequency higher than or equal to the predetermined second frequency.

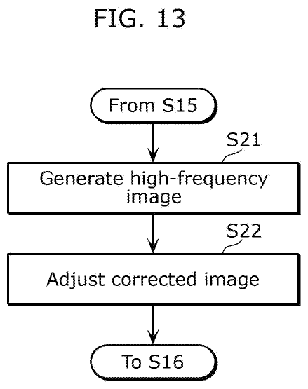

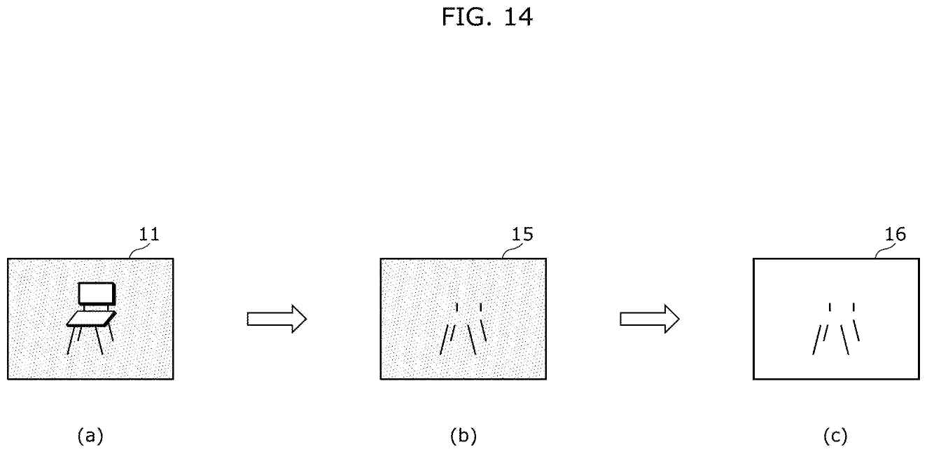

Point cloud data processing device 100 according to Variation 1 makes it possible to reflect, in corrected point cloud data, a shape representing high-frequency components that is not reflected in second range image 12. The following describes such point cloud data processing device 100 according to Variation 1. FIG. 13 is a flowchart illustrating operations performed by point cloud data processing device 100 according to Variation 1 of the embodiment. FIG. 14 is a diagram for illustrating mask processing according to the embodiment. (a) of FIG. 14 is a diagram showing an example of first range image 11 on which the mask processing according to the embodiment is performed. (b) of FIG. 14 is a diagram showing an example of high-frequency image 15 for performing the mask processing according to the embodiment. (c) of FIG. 14 is a diagram showing an example of mask image 16 for performing the mask processing according to the embodiment.

As shown in FIG. 13, first, in step S15 shown in FIG. 7, image processor 150 performs the process for reducing the high-frequency components of difference image 13 each having a frequency higher than or equal to the predetermined first frequency, and generates corrected image 14.

Mask processor 190 extracts frequency components included in first range image 11 and each having a frequency higher than or equal to the predetermined second frequency, and generates high-frequency image 15 (S21). Mask processor 190 extracts the frequency components each having the frequency higher than or equal to the predetermined second frequency by performing a process having a frequency-filtering effect. Examples of the process having the frequency-filtering effect include a frequency transform process, a process for applying a spatial filter, and a process employing AI. It should be noted that the process having the frequency-filtering effect is not limited to the above examples.

The predetermined second frequency is, for example, Fp but may be 1.2 Fp. Specifically, as shown in (a) and (b) of FIG. 14, mask processor 190 generates high-frequency image 15 by performing, on first range image 11, a process for extracting frequency components each having a frequency higher than or equal to the predetermined second frequency. In high-frequency image 15 shown in (b) of FIG. 14, the portions indicated by the solid lines are extracted portions, and the portions indicated by the hatched lines are non-extracted portions. In other words, narrow portions such as the leg portions of the chair shown in (a) of FIG. 14 are extracted from first range image 11 obtained by capturing the chair, and the narrow portions are generated as high-frequency image 15.

When high-frequency image 15 is generated, image processor 150 adjusts corrected image 14 based on high-frequency image 15 generated by mask processor 190 (S22). Specifically, as shown in (c) of FIG. 14, mask processor 190 generates mask image 16 from high-frequency image 15. Image processor 150 adjusts corrected image 14 by combining mask image 16 and corrected image 14 based on mask coefficients. In mask image 16 shown in (c) of FIG. 14, the portions indicated by the solid lines are portions on which the mask processing is to be performed, and the white-colored portions are portions on which the mask processing is not to be performed. To put it another way, in mask image 16 shown in (c) of FIG. 14, mask coefficients are calculated for the portions indicated by the solid lines, and mask coefficients are not calculated for the white-colored portions or invalid values for mask coefficients are calculated for the white-colored portions.

Mask processor 190 calculates mask coefficients for the portions on which the mask processing is to be performed in mask image 16, and image processor 150 adjusts corrected image 14 based on the mask coefficients calculated. For example, mask processor 190 calculates mask coefficients by standardizing pixel values in high-frequency image 15 as coefficients. Mask coefficients may be calculated by performing arithmetic processing such as multiplication or exponentiation on an image obtained by computing a ratio between high-frequency image 15 and first range image 11, and then standardizing pixel values as coefficients. The mask coefficient calculation method is not particularly limited.

Image processor 150 performs, on corrected image 14, a process for masking frequency components each having a frequency higher than or equal to the predetermined second frequency based on the mask coefficients calculated, and generates corrected image 14 that is adjusted. The process for masking may be performed by multiplying pixel values in corrected image 14 by mask coefficients calculated for corrected image 14. Moreover, the process for masking may be performed by calculating an average value of values obtained by multiplying the pixel values in corrected image 14 by the mask coefficients for corrected image 14, and replacing the pixel values with the average value. Furthermore, the process for masking may be performed by performing pixel labeling on portions represented in mask image 16 using AI or connected component calculation, calculating, for each of the label values, an average value of correction amounts for distance values, and replacing the pixel values with the average value. The process for masking is not particularly limited.

When corrected image 14 is adjusted, the process proceeds to step S16 shown in FIG. 7, and corrected data generator 170 generates corrected point cloud data based on corrected image 14 adjusted by image processor 150.

As stated above, since point cloud data processing device 100 according to Variation 1 makes it possible to reflect, in the corrected point cloud data, the shape representing the high-frequency components that is not reflected in second range image 12, point cloud data processing device 100 according to Variation 1 makes it possible to improve the accuracy of blended point cloud data 22.

### Variation 2

In point cloud data processing device 100 according to the above embodiment, an imaging range of first range image 11 is identical to an imaging range of second range image 12. To put it another way, a distance measurement range for distance measurement performed by first distance measurer 130 using unstructured light 111 is identical to a distance measurement range for distance measurement performed by second distance measurer 140 using structured light 112.

However, generally, structured light 112 makes it possible to increase light output more than unstructured light 111 does. In other words, structured light 112 makes it possible to perform distance measurement over a longer distance than unstructured light 111 does. Consequently, second range image 12 makes it possible to include greater distance values than first range image 11 does.

As stated above, when a distance measurement range for ToF performed using unstructured light 111 is wider than a distance measurement range for ToF performed using structured light 112, valid point cloud data calculated based on second range image 12 captured using structured light 112 may be spatially combined with blended point cloud data 22.

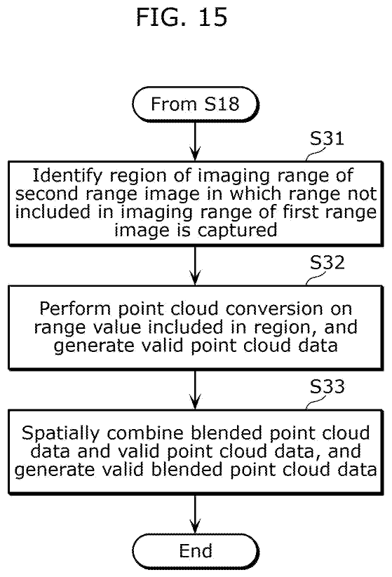

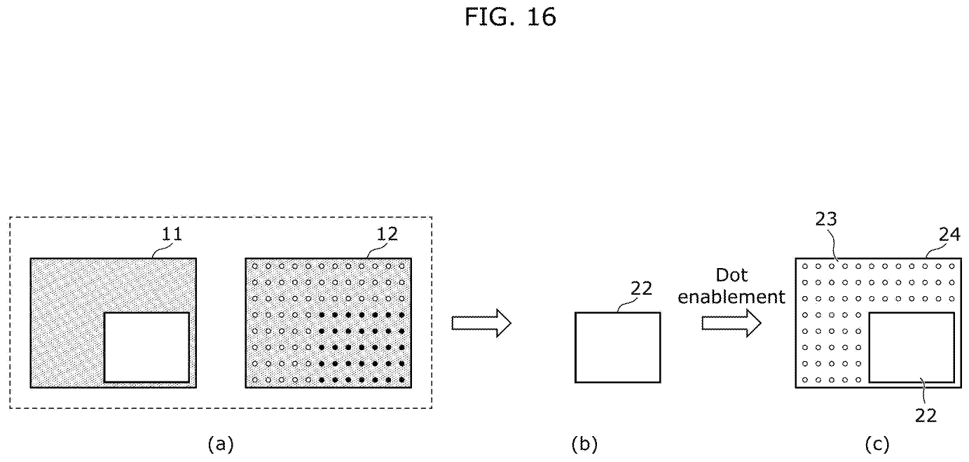

Point cloud data processing device 100 according to Variation 2 makes it possible to generate point cloud data of a spatially wider range, by spatially combining valid point cloud data and blended point cloud data 22, the valid point cloud data being in a range farther than a range of blended point cloud data 22. The following describes such point cloud data processing device 100 according to Variation 2. FIG. 15 is a flowchart illustrating operations performed by point cloud data processing device 100 according to Variation 2 of the embodiment. FIG. 16 is a diagram for illustrating Dot enablement processing according to the embodiment. (a) of FIG. 16 is a diagram illustrating a difference in distance measurement range between first range image 11 and second range image 12. (b) of FIG. 16 is a diagram illustrating a range of blended point cloud data 22. (c) of FIG. 16 is a schematic diagram of valid blended point cloud data 24.

As shown in FIG. 15, first, in step S18 shown in FIG. 7, point cloud corrector 180 generates blended point cloud data. In addition, point cloud converter 160 obtains second range image 12 (not shown in FIG. 3 and FIG. 15).

Next, point cloud converter 160 identifies a region of an imaging range of second range image 12, the region being a region in which a range not included in an imaging range of first range image 11 is captured (S31). In first range image 11 shown in (a) of FIG. 16, the portion represented by the dots is a portion that does not receive a sufficient amount of light for distance calculation because the portion is farther than the distance measurement range for ToF performed using unstructured light 111, and the portion indicated in white is a portion that receives a sufficient amount of light for distance calculation. As a result, the operation of generating blended point cloud data 22 described with reference to FIG. 7 is performed in the portion indicated in white in first range image 11 shown in (a) of FIG. 16. Additionally, in second range image 12 shown in (a) of FIG. 16, the black circles represent effective pixels used to generate blended point cloud data 22, and the white circles represent effective pixels not used to generate blended point cloud data 22. As shown in (b) of FIG. 16 blended point cloud data 22 is generated based on the portion indicated in white in first range image 11 shown in (a) of FIG. 16 and the effective pixels represented by the white circles in second range image 12 shown in (a) of FIG. 16.

Point cloud converter 160 identifies the region of the imaging range of second range image 12, that is, the effective pixels represented by the white circles in second range image 12 shown in (a) of FIG. 16, the region being the region in which the range not included in the imaging range of first range image 11 is captured.

Then, point cloud converter 160 generates valid point cloud data 23 by performing point cloud conversion on range values included in the region of second range image 12 identified (S32). To put it another way, point cloud converter 160 generates valid point cloud data 23 by performing point cloud conversion on distance values based on signals outputted from the effective pixels indicated in white in second range image 12 shown in (a) of FIG. 16. As shown in (c) of FIG. 16, valid point cloud data 23 is point cloud data for a region separated from the region of blended point cloud data 22.

Finally, point cloud corrector 180 generates valid blended point cloud data 24 by spatially combining blended point cloud data 22 generated and valid point cloud data 23 generated by point cloud converter 160 (S33). The term “spatially combining” refers to generating point cloud data for one space by adding point cloud data for two or more different spaces. As shown in (c) of FIG. 16, valid blended point cloud data 24 is point cloud data obtained by spatially combining blended point cloud data 22 and valid point cloud data 23.

By performing the above operations, point cloud data processing device 100 according to Variation 2 makes it possible to generate point cloud data of a spatially wider range, by spatially combining valid point cloud data 23 and blended point cloud data 22, valid point cloud data 23 being in a range farther than a range of blended point cloud data 22. Additionally, since valid point cloud data 23 is less susceptible to the influence of error components caused by multipath because valid point cloud data 23 is point cloud data based on second range image 12, point cloud data processing device 100 makes it possible to generate valid blended point cloud data 24 in which errors caused by multipath are mitigated.

### Variation 3

A timing at which first range image 11 is captured may be different from a timing at which second range image 12 is captured depending on the configuration of point cloud data processing device 100. For example, when point cloud data processing device 100 includes one exposure unit 120, and first distance measurer 130 and second distance measurer 140 alternately capture images using one exposure unit 120, first range image 11 and second range image 12 are not captured at the same timing.

When first range image 11 and second range image 12 are captured at different timings as above, spurious components caused by motion may be generated in difference image 13 when the camera (especially exposure unit 120) or object 200 moves between the timing of capturing first range image 11 and the timing of capturing second range image 12.

Point cloud data processing device 100 according to Variation 3 of the embodiment makes it possible to remove spurious components caused by motion, by performing a time-series filtering process on difference image 13 in a current frame using difference image 13 in a previous frame.

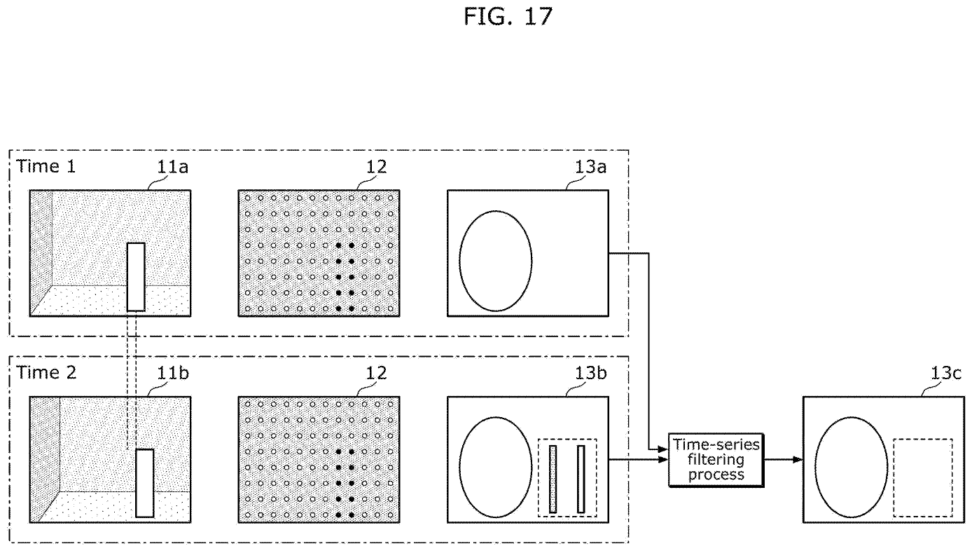

The following describes such a time-series filtering process performed by point cloud data processing device 100 according to Variation 3 of the embodiment. FIG. 17 is a diagram for illustrating the time-series filtering process according to the embodiment.

FIG. 17 shows an example of the time-series filtering process performed when the camera that is stationary at time 1 rotates counterclockwise at time 2 in the case where first distance measurer 130 and second distance measurer 140 alternately capture images using one exposure unit 120. Time 1 shown in FIG. 17 is a time at which second range image 12 is captured by second distance measurer 140. Time 2 shown in FIG. 17 is a frame immediately after time 1 and is a time at which third range image 11b is captured by first distance measurer 130. Image processor 150 generates first difference image 13a based on first range image 11a captured by first distance measurer 130 in a frame immediately before time 1 and second range image 12. Image processor 150 generates second difference image 13b based on third range image 11b and second range image 12.

A comparison between first range image 11a and third range image 11b shown in FIG. 17 indicates that since the camera moves counterclockwise at time 2, the displayed position of an object in the space represented by the white rectangle shifts rightward in third range image 11b. A comparison between first difference image 13a and second difference image 13b shown in FIG. 17 indicates that second difference image 13b includes, in the portion surrounded by the dashed line, components generated when the displayed position of the object shifts rightward, that is, spurious components caused by motion. Since such spurious components caused by motion are generated by the motion of the camera or the object between frames, the spurious components are generated in a spatially narrow range and tend to have a high rate of change in pixel values between the frames.

Image processor 150 generates third difference image 13c by performing the time-series filtering process based on first difference image 13a and second difference image 13b. In third difference image 13c shown in FIG. 17, the spurious components caused by motion included in second difference image 13b are removed from the portion surrounded by the dashed line. The time-series filtering process is a process for removing spurious components caused by motion included in difference image 13b in a current frame using difference image 13a in a previous frame. The following describes a procedure for the time-series filtering process.

First, image processor 150 calculates a degree of similarity between first difference image 13a and second difference image 13b. The degree of similarity includes degrees of proximity between pixel values of pixels in first difference image 13 and pixel values of pixels in second difference image 13b. In other words, a higher degree of similarity is calculated as the differences between the pixel values become smaller. For this reason, a higher degree of similarity is calculated for pixels less susceptible to the influence of the spurious components caused by motion, and a lower degree of similarity is calculated for pixels more susceptible to the influence of the spurious components caused by motion. The degree of similarity is calculated for each of the pixels.

Specifically, image processor 150 calculates the degree of similarity by performing, for example, addition, subtraction, multiplication, and division on pixel values of pixels at corresponding positions in first difference image 13a and second difference image 13b. The degree of similarity may be calculated by processing using AI. It should be noted that the method for calculating a degree of similarity is not limited to the above examples.

Next, image processor 150 generates third difference image 13c by correcting second difference image 13b based on the degree of similarity calculated. For example, image processor 150 corrects second difference image 13b using coefficient processing based on the degree of similarity. To put it another way, the degree of similarity is calculated as a coefficient in a range from 0 to 1, and image processor 150 corrects second difference image 13b by multiplying each of the pixels in second difference image 13b by the coefficient. It should be noted that the correction method is not limited to the above examples.

It should be noted that although the above time-series filtering process is performed using a plurality of difference images generated based on a plurality of different range images captured by first distance measurer 130, the time-series filtering process may be performed using a plurality of difference images generated based on a plurality of different range images captured by second distance measurer 140. In other words, the time-series filtering process may be performed using a difference image generated based on second range image 12 and a difference image generated based on a fourth range image captured by second distance measurer 140 after second range image 12.

More specifically, after second distance measurer 140 captures second range image 12, second distance measurer 140 captures the fourth range image using structured light 112. Image processor 150 generates a fourth difference image based on second range image 12 and a fifth difference image based on the fourth range image. Image processor 150 generates a sixth difference image by performing the time-series filtering process based on the fourth difference image and the fifth difference image. To put it another way, image processor 150 calculates a degree of similarity between the fourth difference image and the fifth difference image, and generates the sixth difference image by correcting the fifth difference image using the degree of similarity calculated. Corrected data generator 170 generates corrected point cloud data based on the sixth difference image generated by image processor 150. The fourth difference image corresponds to above-described first difference image 13a, the fifth difference image corresponds to above-described second difference image 13b, and the sixth difference image corresponds to above-described third difference image 13c.

As stated above, image processor 150 makes it possible to remove spurious components caused by motion, by correcting a difference image using the time-series filtering process, using a plurality of difference images generated based on the results of distance measurements performed at a plurality of times.

When the difference image from which the spurious components caused by motion are removed is generated, the process proceeds to step S15 shown in FIG. 7, image processor 150 performs a process for reducing frequency components each having a frequency higher than or equal to the predetermined first frequency, and generates a corrected image based on the difference image from which the spurious components caused by motion are removed. Subsequently, corrected data generator 170 generates corrected point cloud data based on the corrected image.

It should be noted that the time-series filtering process may be applied not to a difference image but to a corrected image. More specifically, image processor 150 generates a first corrected image by performing, on first difference image 13a, the process for reducing the frequency components each having the frequency higher than or equal to the predetermined first frequency; and generates a second corrected image by performing, on second difference image 13b, the process for reducing the frequency components each having the frequency higher than or equal to the predetermined first frequency. Next, image processor 150 generates a third corrected image by performing the above time-series filtering process based on the first corrected image and the second corrected image generated. Finally, corrected data generator 170 may generate corrected point cloud data based on the third corrected image. Accordingly, point cloud data processing device 100 makes it possible to generate the third corrected image from which spurious components caused by motion that may be included in the second corrected image are removed.

It should be noted that although the degree of similarity is calculated by comparing a frame with an immediately previous frame in the above time-series filtering process, the degree of similarity may be calculated by comparing a frame with a frame preceding the immediately previous frame or with two or more previous frames.

It should be noted that the time-series filtering process may be performed on all or part of the pixels included in second difference image 13b.

It should be noted that although the camera is stationary at time 1 in the above example shown in FIG. 17, the camera may move at time 1. This is because image processor 150 makes it possible to remove spurious components caused by motion included in first difference image 13, by performing the time-series filtering process on first difference image 13a obtained at time 1, using a difference image obtained before time 1.

As described above, when first range image 11 and second range image 12 are captured at different timings, point cloud data processing device 100 according to Variation 3 makes it possible to remove spurious components caused by motion that may be included in difference image 13. Accordingly, point cloud data processing device 100 according to Variation 3 makes it possible to generate blended point cloud data 22 in which errors caused by the motion of the camera or object 200 are mitigated.

### Advantageous Effects Etc.

Examples of techniques derived from the present disclosure are as follows. The following describes the techniques derived from the present disclosure together with the advantageous effects and the like produced by the techniques.

Technique 1 is point cloud data processing device 100 that includes: first distance measurer 130 that captures first range image 11 using unstructured light 111; second distance measurer 140 that captures second range image 12 using structured light 112; image processor 150 that generates difference image 13 based on first range image 11 captured by first distance measurer 130 and second range image 12 captured by second distance measurer 140, difference image 13 indicating a difference between first range image 11 and second range image 12; point cloud converter 160 that performs, based on first range image 11 captured by first distance measurer 130, point cloud conversion on a distance value included in first range image 11, and generates first point cloud data 21; corrected data generator 170 that generates corrected point cloud data based on difference image 13 generated by image processor 150; and point cloud corrector 180 that generates blended point cloud data 22 by correcting first point cloud data 21 based on the corrected point cloud data generated by corrected data generator 170.

Point cloud data processing device 100 generates corrected point cloud data based on first range image 11 captured using unstructured light 111 and second range image 12 captured using structured light 112, and generates blended point cloud data 22 by correcting first point cloud data 21 obtained from first range image 11 based on the corrected point cloud data. Accordingly, point cloud data processing device 100 makes it possible to generate point cloud data in which errors caused by multipath at the time of distance measurement are mitigated.

Technique 2 is point cloud data processing device 100 according to Technique 1, in which image processor 150 generates reduced image 12a by extracting an effective pixel included in second range image 12, and generates difference image 13 based on first range image 11 and reduced image 12a.

Point cloud data processing device 100 makes it possible to generate corrected point cloud data using a distance value calculated based on a signal outputted by an effective pixel that receives a sufficient amount of light for distance measurement. Accordingly, point cloud data processing device 100 makes it possible to generate point cloud data in which errors caused by multipath at the time of distance measurement are mitigated.

Technique 3 is point cloud data processing device 100 according to Technique 1 or 2, in which image processor 150 performs, on difference image 13 generated, a process for reducing a frequency component having a frequency higher than or equal to a predetermined first frequency, and corrected data generator 170 generates the corrected point cloud data based on difference image 13 on which the process is performed. Difference image 13 on which the process is performed is an example of corrected image 14 in the above-described embodiment.

Point cloud data processing device 100 makes it possible to extract, from error components included in difference image 13, error components caused by, for example, multipath and a low-reflectivity object and representing relatively low-frequency components, and reflect the error components in the corrected point cloud data.

Technique 4 is point cloud data processing device 100 according to Technique 3, in which image processor 150 performs frequency transform on difference image 13, and performs the process.

Since point cloud data processing device 100 makes it possible to perform a process for reducing high-frequency components while handling frequency data by actually performing frequency transform on difference image 13, point cloud data processing device 100 makes it possible to improve the accuracy of the process.

Technique 5 is point cloud data processing device 100 according to Technique 3, in which image processor 150 performs the process by applying a spatial filter to difference image 13.

Since point cloud data processing device 100 makes it possible to perform a process for reducing high-frequency components without converting difference image 13 into frequency data by applying a spatial filter to difference image 13, point cloud data processing device 100 makes it possible to reduce the amount of calculation required for the process.

Technique 6 is point cloud data processing device 100 according to Technique 3, in which image processor 150 performs the process using artificial intelligence (AI).

Since point cloud data processing device 100 makes it possible to perform the process for reducing the high-frequency components by inputting difference image 13 to trained AI, point cloud data processing device 100 makes it possible to easily perform the process.

Technique 7 is point cloud data processing device 100 according to any one of Techniques 3 to 6 further including: mask processor 190 that extracts a frequency component included in first range image 11 and having a frequency higher than or equal to a predetermined second frequency, and generates high-frequency image 15. Image processor 150 adjusts difference image 13 on which the process is performed, based on high-frequency image 15 generated by mask processor 190, and corrected data generator 170 generates the corrected point cloud data based on difference image 13 on which the process is performed and that is adjusted by image processor 150.

Since point cloud data processing device 100 makes it possible to reflect, in the corrected point cloud data, a shape representing high-frequency components that is not reflected in second range image 12, point cloud data processing device 100 makes it possible to improve the accuracy of blended point cloud data 22.

Technique 8 is point cloud data processing device 100 according to any one of Techniques 1 to 7, in which point cloud converter 160 identifies a region of an imaging range of second range image 12, and generates valid point cloud data by performing point cloud conversion on a range value included in the region of second range image 12 identified, the region being a region in which a range not included in an imaging range of first range image 11 is captured, and point cloud corrector 160 generates valid blended point cloud data 24 by spatially combining blended point cloud data 22 generated and valid point cloud data 23 generated by point cloud converter 160.

Point cloud data processing device 100 makes it possible to generate valid blended point cloud data 24 of a spatially wider range by spatially combining valid point cloud data 23 and blended point cloud data 22, valid point cloud data 23 being in a range farther than a range of blended point cloud data 22. Additionally, since valid point cloud data 23 is less susceptible to the influence of error components caused by multipath because valid point cloud data 23 is point cloud data based on second range image 12, point cloud data processing device 100 makes it possible to generate valid blended point cloud data 24 in which errors caused by multipath are mitigated.

Technique 9 is point cloud data processing device 100 according to Technique 1 or 2, in which after first distance measurer 130 captures first range image 11a, first distance measurer 130 captures third range image 11b using unstructured light 111, image processor 150 generates first difference image 13a based on first range image 11a and second difference image 13b based on third range image 11b, and generates third difference image 13c based on first difference image 13a and second difference image 13b, and corrected data generator 170 generates the corrected point cloud data based on third difference image 13c generated by image processor 150.

When first range image 11 and second range image 12 are captured at different timings, point cloud data processing device 100 makes it possible to remove spurious components caused by motion that may be included in difference image 13.

Accordingly, point cloud data processing device 100 makes it possible to generate point cloud data in which errors caused by the motion of a camera or object 200 are mitigated.

Technique 10 is point cloud data processing device 100 according to Technique 9, in which image processor 150 performs, on third difference image 13c generated, a process for reducing a frequency component having a frequency higher than or equal to a predetermined first frequency, and corrected data generator 170 generates the corrected point cloud data based on third difference image 13c on which the process is performed.

Point cloud data processing device 100 makes it possible to extract, from error components included in third difference image 13c, error components caused by, for example, multipath and a low-reflectivity object and representing relatively low-frequency components, and reflect the error components in the corrected point cloud data.

Technique 11 is point cloud data processing device 100 according to Technique 1 or 2, in which after second distance measurer 140 captures the second range image, second distance measurer 140 captures a fourth range image using structured light 112, image processor 150 generates a fourth difference image based on the second range image and a fifth difference image based on the fourth range image, and generates a sixth difference image based on the fourth difference image and the fifth difference image, and corrected data generator 170 generates the corrected point cloud data based on the sixth difference image generated by image processor 150.

When first range image 11 and second range image 12 are captured at different timings, point cloud data processing device 100 makes it possible to remove spurious components caused by motion that may be included in difference image 13. Accordingly, point cloud data processing device 100 makes it possible to generate point cloud data in which errors caused by the motion of a camera or object 200 are mitigated.

Technique 12 is point cloud data processing device 100 according to Technique 11, in which image processor 150 performs, on the sixth difference image generated, a process for reducing a frequency component having a frequency higher than or equal to a predetermined first frequency, and corrected data generator 170 generates the corrected point cloud data based on the sixth difference image on which the process is performed.

Point cloud data processing device 100 makes it possible to extract, from error components included in the sixth difference image, error components caused by, for example, multipath and a low-reflectivity object and representing relatively low-frequency components, and reflect the error components in the corrected point cloud data.

Technique 13 is a point cloud data processing method that includes: capturing first range image 11 using unstructured light 111; capturing second range image 12 using structured light 112; generating difference image 13 based on first range image 11 captured in the capturing of first range image 11 and second range image 12 captured in the capturing of second range image 12, difference image 13 indicating a difference between first range image 11 and second range image 12; performing, based on first range image 11 captured in the capturing of first range image 11, point cloud conversion on a distance value included in first range image 11, and generating first point cloud data 21; generating corrected point cloud data based on difference image 13 generated in the generating of difference image 13; and generating blended point cloud data 22 by correcting first point cloud data 21 based on the corrected point cloud data generated in the generating of the corrected point cloud data.

The point cloud data processing method generates corrected point cloud data based on first range image 11 captured using unstructured light 111 and second range image 12 captured using structured light 112, and generates blended point cloud data 22 by correcting first point cloud data 21 obtained from first range image 11 based on the corrected point cloud data. Accordingly, the point cloud data processing method makes it possible to generate point cloud data in which errors caused by multipath at the time of distance measurement are mitigated.

Technique 14 is a non-transitory computer-readable recording medium having recorded thereon a program for causing a computer to execute the point cloud data processing method according to Technique 13.

The recording medium makes it possible to assist in generating point cloud data in which errors caused by multipath at the time of distance measurement are mitigated.

### OTHER EMBODIMENTS

Although the embodiment is described above, the present disclosure is not limited to the above embodiment.

For example, although corrected data generator 170 generates corrected point cloud data based on corrected image 14 in step S16 shown in FIG. 7 in the above embodiment, corrected data generator 170 may generate corrected point cloud data based on difference image 13. In other words, step S15 shown in FIG. 7 may be omitted. Point cloud data processing device 100 makes it possible to generate corrected point cloud data that includes error components caused by second range image 12 having a low resolution in addition to error components caused by multipath.

Moreover, for example, although point cloud data processing device 100 is implemented by a single device in the above embodiment, point cloud data processing device 100 may be implemented by a plurality of devices. When point cloud data processing device 100 is implemented by a plurality of devices, the constituent elements (especially functional constituent elements) included in point cloud data processing device 100 may be assigned to the plurality of devices in any manner.

For example, although point cloud data processing device 100 includes the distance measuring device including light emitter 110 and exposure unit 120 in the above embodiment, point cloud data processing device 100 may be a device that does not include the distance measuring device, receives range images captured, and performs information processing on the range images received.

Furthermore, a method for communicating between devices in the above embodiment is not particularly limited. In addition, communication between the devices may be performed via a relay device (e.g., a gateway device) not shown in the drawings.

Moreover, in the above embodiment, processing performed by a specific processing unit may be performed by another processing unit. Additionally, the order of a plurality of processes may be changed, and a plurality of processes may be performed in parallel.

Furthermore, in the above embodiment, each of the constituent elements may be implemented by executing a software program suitable for the constituent element. Each constituent element may be implemented by a program executer, such as a central processing unit (CPU) or a processor, reading out and executing a software program stored in a recording medium, such as a hard disk drive or semiconductor memory.

Moreover, each of the constituent elements may be implemented by hardware. For example, each constituent element may be a circuit (or an integrated circuit). These circuits may be configured as a single circuit or may be individual circuits. In addition, each of the circuits may be a general-purpose circuit or a dedicated circuit.

Furthermore, the comprehensive or specific aspects of the present disclosure may be implemented by a system, a device, a method, an integrated circuit, a computer program, or a computer-readable recording medium such as a CD-ROM. Additionally, the comprehensive or specific aspects of the present disclosure may be implemented in any combination of systems, devices, integrated circuits, computer programs, and recording media.

Moreover, the present disclosure may be implemented as a point cloud data processing method performed by a computer such as point cloud data processing device 100 according to the above embodiment, or may be implemented as a program (i.e., a computer program product) for causing a computer to perform the point cloud data processing method. In addition, the present disclosure may be implemented as a non-transitory computer-readable recording medium on which such a program is recorded.

Forms obtained by making various modifications to the embodiment that can be conceived by a person skilled in the art or forms realized by any combination of the constituent elements and the functions in the embodiment without departing from the essence of the present disclosure are included in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

A point cloud data processing device according to the present disclosure is applicable to an information processing apparatus that generates point cloud data indicating the shape of a physically existing object based on data obtained by capturing the object.

1. A point cloud data processing device comprising:
a first distance measurer that captures a first range image using an unstructured light;
a second distance measurer that captures a second range image using a structured light;
an image processor that generates a difference image based on the first range image captured by the first distance measurer and the second range image captured by the second distance measurer, the difference image indicating a difference between the first range image and the second range image;
a point cloud converter that performs, based on the first range image captured by the first distance measurer, point cloud conversion on a distance value included in the first range image, and generates first point cloud data;
a corrected data generator that generates corrected point cloud data based on the difference image generated by the image processor; and
a point cloud corrector that generates blended point cloud data by correcting the first point cloud data based on the corrected point cloud data generated by the corrected data generator.

2. The point cloud data processing device according to claim 1,
wherein the image processor generates a reduced image by extracting an effective pixel included in the second range image, and generates the difference image based on the first range image and the reduced image.

3. The point cloud data processing device according to claim 1,
wherein the image processor performs, on the difference image generated, a process for reducing a frequency component having a frequency higher than or equal to a predetermined first frequency, and
the corrected data generator generates the corrected point cloud data based on the difference image on which the process is performed.

4. The point cloud data processing device according to claim 3,
wherein the image processor performs frequency transform on the difference image, and performs the process.

5. The point cloud data processing device according to claim 3,
wherein the image processor performs the process by applying a spatial filter to the difference image.

6. The point cloud data processing device according to claim 3,
wherein the image processor performs the process using artificial intelligence (AI).

7. The point cloud data processing device according to claim 3, further comprising:
a mask processor that extracts a frequency component included in the first range image and having a frequency higher than or equal to a predetermined second frequency, and generates a high-frequency image,
wherein the image processor adjusts the difference image on which the process is performed, based on the high-frequency image generated by the mask processor, and
the corrected data generator generates the corrected point cloud data based on the difference image on which the process is performed and that is adjusted by the image processor.

8. The point cloud data processing device according to claim 1,
wherein the point cloud converter identifies a region of an imaging range of the second range image, and generates valid point cloud data by performing point cloud conversion on a range value included in the region of the second range image identified, the region being a region in which a range not included in an imaging range of the first range image is captured, and
the point cloud corrector generates valid blended point cloud data by spatially combining the blended point cloud data generated and the valid point cloud data generated by the point cloud converter.

9. The point cloud data processing device according to claim 1,
wherein after the first distance measurer captures the first range image, the first distance measurer captures a third range image using the unstructured light,
the image processor generates a first difference image based on the first range image and a second difference image based on the third range image, and generates a third difference image based on the first difference image and the second difference image, and
the corrected data generator generates the corrected point cloud data based on the third difference image generated by the image processor.

10. The point cloud data processing device according to claim 9,
wherein the image processor performs, on the third difference image generated, a process for reducing a frequency component having a frequency higher than or equal to a predetermined first frequency, and
the corrected data generator generates the corrected point cloud data based on the third difference image on which the process is performed.

11. The point cloud data processing device according to claim 1,
wherein after the second distance measurer captures the second range image, the second distance measurer captures a fourth range image using the structured light,
the image processor generates a fourth difference image based on the second range image and a fifth difference image based on the fourth range image, and generates a sixth difference image based on the fourth difference image and the fifth difference image, and
the corrected data generator generates the corrected point cloud data based on the sixth difference image generated by the image processor.

12. The point cloud data processing device according to claim 11,
wherein the image processor performs, on the sixth difference image generated, a process for reducing a frequency component having a frequency higher than or equal to a predetermined first frequency, and
the corrected data generator generates the corrected point cloud data based on the sixth difference image on which the process is performed.

13. A point cloud data processing method comprising:
capturing a first range image using an unstructured light;
capturing a second range image using a structured light;
generating a difference image based on the first range image captured in the capturing of the first range image and the second range image captured in the capturing of the second range image, the difference image indicating a difference between the first range image and the second range image;
performing, based on the first range image captured in the capturing of the first range image, point cloud conversion on a distance value included in the first range image, and generating first point cloud data;
generating corrected point cloud data based on the difference image generated in the generating of the difference image; and
generating blended point cloud data by correcting the first point cloud data based on the corrected point cloud data generated in the generating of the corrected point cloud data.

14. A non-transitory computer-readable recording medium having recorded thereon a program for causing a computer to execute the point cloud data processing method according to claim 13.
